(19) United States
(12) Patent Application Publication
(10) Pub. No.: US 2011/0281161 A1
(43) Pub. Date: Nov. 17, 2011

(54) LITHIUM SECONDARY BATTERY

(76) Inventors: Hiroaki Ikeda, Aichi-ken (JP); Hitoshi Sakai, Aichi-ken (JP); Ryuta Morishima, Aichi-ken (JP); Hiroyuki Akita, Aichi-ken (JP); Hidehito Matsuo, Aichi-ken (JP)

(21) Appl. No.: 13/146,034

(22) PCT Filed: Feb. 9, 2009
(86) PCT No.: PCT/JP2009/052179

§ 371 Date: Jul. 25, 2011

(51) Int. Cl. H01M 10/052; H01M 4/13

(52) U.S. Cl. 429/211

(57) ABSTRACT

The lithium secondary battery provided by the present invention includes an electrode provided with an insulating particle-containing layer (34) having a configuration in which an active material layer (344) is retained on a current collector (342), and an insulating particle-containing layer (346), containing insulating particles (44) and a binder (46), is provided on the active material layer (344). A portion (346A) of the insulating particle-containing layer (346) facing the active material layer contains the binder (46) at a higher weight content than a portion (346B) facing an outer surface thereof.

### TECHNICAL FIELD

The present invention relates to a lithium secondary battery provided with an electrode of a configuration having an insulating particle-containing layer on an active material layer.

### BACKGROUND ART

The importance of lithium secondary batteries and other non-aqueous secondary batteries is continuing to increase as vehicle-mounted power supplies used in vehicles powered by electricity and as power supplies installed in personal computers, handheld devices and other electrical products. In particular, lithium ion batteries are expected to be preferably used as high-output, vehicle-mounted power supplies due to their light weight and high energy density. Patent Document 1 is an example of a technical document relating to a non-aqueous secondary battery.

A typical electrode provided in a lithium ion battery has a configuration in which a layer (active material layer) mainly composed of a material capable of reversibly absorbing and releasing lithium (Li) (active material) is retained on an electrically conductive member (current collector). An example of a preferable method for forming this active material layer consists of coating a composition prepared by dispersing or dissolving a particulate active material (active material particles) in a suitable solvent to form a paste or slurry, drying, and compressing as necessary.

An electrode has been proposed of a configuration in which a layer containing insulating particles (insulating particle-containing layer) is provided on a surface of such an active material layer. The insulating particle-containing layer typically further contains a binder having the functions of mutually binding the insulating particles and retaining the particles (and in turn the insulating particle-containing layer) on the active material layer. For example, Patent Document 1 describes using two outside layers of three or more layers coated onto a current collector as layers containing insulating solid fine particles, and making the solid fine particle contents of the outermost layers 5% or more lower than that of the adjacent layer (namely, the layer arranged to the inside of the outermost layers).
Patent Document 1: Japanese Patent Application Laid-open No. H 10-97874

The providing of an insulating particle-containing layer on a surface of an active material not only serves as effective means for improving reliability of a lithium secondary battery (by, for example, preventing internal short-circuiting), but also can also contribute to improved battery durability (by, for example, enhancing capacity retention with respect to repeated charging and discharging). It would therefore be beneficial to provide a technology that enables the functions of this insulating particle-containing layer to be exhibited more suitably.

### DISCLOSURE OF THE INVENTION

Therefore, an object of the present invention is to provide a lithium secondary battery exhibiting higher performance that is provided with an electrode having an insulating particle-containing layer on an active material layer.

The lithium secondary battery provided by the present invention includes a positive electrode; a negative electrode; and a non-aqueous electrolyte. One of the positive electrode and the negative electrode is an electrode provided with an insulating particle-containing layer having a configuration in which an active material layer mainly composed of an active material is retained on a current collector, and the insulating particle-containing layer containing insulating particles and a binder that binds the particles is provided on the active material layer. A portion of the insulating particle-containing layer facing the active material layer contains the binder at a higher weight content than that of a portion of the insulating particle-containing layer facing an outer surface thereof.

In the case of attempting to improve durability of the battery (by, for example, improving cycling characteristics such as capacity retention rate) by providing the insulating particle-containing layer on the active material layer, it is advantageous to make the weight content of the binder (binder content) in the insulating particle-containing layer higher from the viewpoint of adhesion between the insulating particle-containing layer and the active material layer. However, when the binder content of the insulating particle-containing layer is increased, migration of Li ions is inhibited by the binder, thereby tending to increase internal resistance of the battery. Namely, it is preferable to lower the binder content from the viewpoint of reducing internal resistance. Consequently, it has been difficult to realize high levels of improvement of durability and suppression of increases in internal resistance values by simply increasing or decreasing the overall binder content of the insulating particle-containing layer.

In the technology disclosed herein, by making the binder content of an inside portion of the insulating particle-containing layer contacting the active material layer (portion facing the active material layer) relatively high, adhesion (bonding strength) between the active material layer and the insulating particle-containing layer can be enhanced, while on the other hand, by making the binder content in a portion of the insulating particle-containing layer facing the outer surface relatively low, inhibition of Li ion migration can be reduced. Thus, according to an electrode (such as a negative electrode) provided with an insulating particle-containing layer having an insulating particle-containing layer of this configuration, a high-performance lithium secondary battery can be provided that has a high capacity retention rate and a low internal resistance value.

Furthermore, in the present description, a “lithium secondary battery” refers to a secondary battery that uses lithium ions as electrolyte ions and in which charging and discharging are realized by migration of lithium ions between positive and negative electrodes. A secondary battery generally referred to as a lithium ion battery is a typical example that is included in a lithium secondary battery in the present description.

In a preferable aspect of the technology disclosed herein, the insulating particle-containing layer contains two or more sub-layers in which weight contents of the binder (binder contents) differ. The binder contents of the sub-layers are set such that the binder content C_{IN} of the innermost layer is higher than the binder content C_{OUT} of the outermost layer. According to this configuration, an insulating particle-containing layer in which the binder content of the inside portion is higher than that of the outside portion can be realized easily. In addition, the binder contents of the inside portion and the outside portion of the insulating particle-containing layer are easily and accurately controlled, thereby making this preferable in terms of quality control.

The technology disclosed herein can be preferably carried out in an aspect in which, among the sub-layers that compose the insulating particle-containing layer, the binder content C_{IN} of the innermost layer is highest, while the binder content C_{OUT} of the outermost layer is lowest. Namely, in the case of the insulating particle-containing layer containing three or more sub-layers, binder contents of sub-layers positioned between the outermost layer and the innermost layer are all preferably between C_{OUT} and C_{IN}.

In a preferable aspect, the binder content C_{IN} of the innermost layer is within a range of roughly 1.02 times to 1.25 times the binder content C_{OUT} of the outermost layer. By making C_{IN}/C_{OUT} to be within the above range, increases in an internal resistance value accompanying installation of the insulating particle-containing layer can be more effectively suppressed.

In another preferable aspect, the binder content C_{IN} of the innermost layer is roughly 1.1 times to 1.25 times the binder content C_{OUT} of the outermost layer. By making C_{IN}/C_{OUT} to be within the above range, increases in an internal resistance can be effectively suppressed while further improving capacity retention rate.

In a preferable aspect of the lithium secondary battery disclosed herein, a lithium ion battery is exemplified in which the electrode provided with an insulating particle-containing layer is used as a negative electrode. A carbon material having a graphite structure in at least a portion thereof (such as graphite particles) can be preferably employed for the negative electrode active material in this aspect.

Since the lithium secondary battery disclosed herein (and typically, a lithium ion battery) can possess high performance as previously described (such as exhibiting favorable durability with respect to a charge/discharge cycle of a high rate of 2 C or more while also exhibiting superior input/output performance due to a low internal resistance value), it is preferable for use as a lithium secondary battery installed in a vehicle. For example, it can be preferably used as a power source for a motor of a vehicle such as an automobile in the form of a battery assembly in which a plurality of the lithium secondary batteries is connected in series. Thus, according to the present invention, a vehicle is provided that includes any of the lithium secondary batteries disclosed herein.

### BRIEF DESCRIPTION OF THE DRAWINGS

FIG. 1 is a schematic cross-sectional view showing the structure of a lithium ion battery according to an embodiment;

FIG. 2 is a schematic cross-sectional view showing a positive electrode sheet, a negative electrode sheet and separators that compose a lithium ion battery according to an embodiment;

FIG. 3 is a schematic drawing showing an enlarged view of a portion of FIG. 2;

FIG. 4 is an explanatory drawing schematically showing the effects a charge/discharge cycle can have on an electrode of a configuration that does not have an insulating particle-containing layer on an active material;

FIG. 5 is a graph indicating the relationship between binder content ratio (C_{IN}/C_{OUT}) between an outermost layer and an innermost layer and an internal resistance value;

FIG. 6 is a graph indicating the relationship between binder content ratio (C_{IN}/C_{OUT}) between an outermost layer and an innermost layer and capacity retention rate after 500 cycles;

FIG. 7 is a graph indicating the relationship between surface roughness Ra of an active material layer and capacity retention rate after 2000 cycles;

FIG. 8 is an explanatory drawing schematically exemplifying the status of an electrode in which an insulating particle-containing layer is provided on an active material layer having small surface roughness Ra before and after charge/discharge cycling;

FIG. 9 is an explanatory drawing schematically exemplifying the status of an electrode in which an insulating particle-containing layer is provided on an active material layer having suitable surface roughness Ra before and after charge/discharge cycling;

FIG. 10 is an explanatory drawing schematically exemplifying the status of an electrode in which an insulating particle-containing layer is provided on an active material layer having large surface roughness Ra before and after charge/discharge cycling; and

FIG. 11 is a side view schematically showing a vehicle (automobile) provided with a lithium secondary battery.

### BEST MODE FOR CARRYING OUT THE INVENTION

The following provides an explanation of preferred embodiments of the present invention. Those matters required for carrying out the present invention other than matters specifically mentioned in the present description can be understood to be design matters for a person with ordinary skill in the art based on the prior art in the relevant field. The present invention can be carried out based on the contents disclosed in the present description and common general technical knowledge in the relevant field.

The technology disclosed herein can be widely applied to an electrode of a configuration having an active material layer retained on a current collector and an insulating particle-containing layer on the active material layer (electrode with insulating particle-containing layer) and the production thereof, a lithium secondary battery provided with the electrode and the production thereof, and a vehicle equipped with that battery. Although the following provides an explanation of the present invention using as examples thereof mainly the cases of applying the present invention to an electrode for a lithium ion battery (and particularly a negative electrode) and a lithium ion battery provided with that electrode, the explanation is not intended to limit the application targets of the present invention to this electrode or battery.

The electrode provided according to the technology disclosed herein has a configuration in which an insulating particle-containing layer (and typically, a porous layer) containing insulating particles and a binder is provided on an active material layer. An insulating particle-containing layer of a composition mainly composed of insulating particles (component accounting for 50% by weight or more) is preferable. The material that composes the insulating particles (and typically, an inorganic material) can be a non-electrically conductive material (insulating material) selected from oxides, carbides, silicides or nitrides and the like of metal elements or non-metal elements. Insulating particles that do not substantially absorb or release Li ions (or in other words, that do not substantially function as an active material) are preferable. Oxide particles such as alumina (Al₂O₃), silica (SiO₂), zirconia (ZrO₂) or magnesia (MgO) can be preferably employed as insulating particles in the technology disclosed herein from the viewpoints of chemical stability, raw material cost and the like. In addition, silicide particles such as silicon carbide (SiC) or nitride particles such as aluminum nitride (AlN) can also be used. Alumina particles constitute a particularly preferably example of insulating particles in the present invention. In particular, α-alumina particles are used preferably.

The mean particle diameter of the insulating particles can be, for example, roughly 0.1 μm to 15 μm. A value obtained with an ordinary, commercially-available particle size analyzer (such as a laser diffraction particle size analyzer) can be employed for the value of mean particle diameter (D₅₀) on a volume basis. Normally, insulating particles having a mean particle diameter of roughly 0.2 μm to 1.5 μm (for example, 0.5 μm to 1 μm) are used preferably. An electrode (such as a negative electrode) of a configuration in which a layer containing insulating particles of this mean particle diameter is provided on an active material layer is able to realize a lithium secondary battery possessing higher performance.

In addition to the insulating particles, the insulating particle-containing layer in the technology disclosed herein also contains a binder that binds the insulating particles. Examples of this binder include rubbers containing acrylonitrile as a copolymer component such as acrylonitrile-butadiene copolymer rubber (NBR), acrylonitrile-isoprene copolymer rubber (NIR), acrylic acid ester or acrylonitrile-butadiene-isoprene copolymer rubber (NBIR); acrylic polymers having as the main copolymer component thereof an acrylic monomer such as acrylic acid, methacrylic acid or methacrylic acid ester (for example, alkyl ester); and vinyl acetate-based resins such as polyvinyl acetate or ethylene-vinyl acetate copolymer (EVA). In addition, one type or two or more types of materials suitably selected from polymers listed as examples of binders that can be used in a negative electrode active material layer to be explained later may also be used as binder of the insulating particle-containing layer. In a preferable aspect of the insulating particle-containing layer disclosed herein, the insulating particle-containing layer contains an acrylic binder. The insulating particle-containing layer may also be an insulating particle-containing layer of a composition that substantially contains only acrylic binder as binder.

The insulating particle-containing layer is characterized by containing a binder at a higher weight ratio in the portion facing the active material layer (inside) than the portion facing the outer surface. An insulating particle-containing layer in which the binder content varies relative to the direction of thickness in this manner (namely, containing a binder unevenly distributed towards the active material layer) can be preferably formed by, for example, laminating two or more sub-layers having different binder contents. Namely, a binder content C_{IN} of a sub-layer arranged farthest to the inside of the active material layer (innermost layer) is made to be higher than a binder content C_{OUT} of a sub-layer arranged farthest to the outside (outermost layer). A method consisting of coating a composition having a corresponding binder content (and typically, a liquid composition containing the insulating particles, a binder and a suitable solvent) followed by drying can be preferably employed for forming each sub-layer. An example of another technique for producing an insulating particle-containing layer containing a binder unevenly distributed to the inside consists of arranging a required amount of binder on the surface of an active material layer (in a form that is able to be arranged thereon, such as a powder, coating or thick solution), followed by coating a composition for forming an insulating particle-containing layer thereon (and typically, a liquid composition containing the insulating particles, a binder and a suitable solvent) and drying.

The number of sub-layers formed that compose the insulating particle-containing layer may be two or three or more. In an insulating particle-containing layer containing three or more sub-layers, the binder content of the sub-layer positioned between the outermost layer and the innermost layer is preferably between that of C_{OUT} and C_{IN}. According to this configuration, improvement of capacity retention rate and reduction of internal resistance can both be realized at higher levels. For example, an arrangement can be preferably employed such that binder content sequentially becomes lower moving from the inside sub-layer towards the outside sub-layer.

The types of insulating particles and binder contained in the sub-layers may be mutually the same or different. Normally, it is preferable to make the materials that compose each sub-layer substantially the same while making the composite ratios of the materials thereof (and particularly, the binder contents thereof) different. An insulating particle-containing layer employing this configuration offers the advantage of enhancing adhesion between the sub-layers.

In a preferable aspect of the technology disclosed herein, the number of sub-layers that compose the insulating particle-containing layer is two (namely, the insulating particle-containing layer has a bilayer structure). According to this configuration, an insulating particle-containing layer can be realized that contains binder unevenly distributed to the inside by the fewest number of sub-layers. This is advantageous in terms of reducing internal resistance, and is also preferable from the viewpoints of cost and productivity.

The degree to which the binder content C_{IN} of the innermost layer is made to be higher than the binder content C_{OUT} of the outermost layer is such that, for example, C_{IN}/C_{OUT} is suitably within the range of about 1.005 to 5. If C_{IN}/C_{OUT} is too greater than this range, the binder content of the inside portion becomes excessively high, thereby causing an increase in the internal resistance value, or causing a decrease in durability due to the binder content of the outside portion being excessively low. If C_{IN}/C_{OUT} is too smaller than this range (closer to 1), it may be difficult to adequately exhibit the effect of making the binder contents different between the outside and inside.

Normally, C_{IN}/C_{OUT} is preferably 1.3 or less (for example, 1.02 to 1.25). According to an electrode having an insulating particle-containing layer of this configuration, a battery can be realized that exhibits a lower value of internal resistance. In addition, C_{IN}/C_{OUT} is preferably 1.05 or more (for example, 1.05 to 2) and more preferably 1.1 or more (for example, 1.1 to 1.5). According to an electrode having an insulating particle-containing layer of this configuration, a battery can be realized that exhibits a higher capacity retention rate. As a result of making C_{IN}/C_{OUT} to be within the range of 1.05 to 1.25 (and more preferably, 1.1 to 1.25), increases in internal resistance can be effectively suppressed while further improving capacity retention rate.

The binder content of each sub-layer can be within the range of, for example, roughly 0.5% to 20% by weight, and normally, is preferably made to be within the range of 1% to 15% by weight (and more preferably, 2% to 10% by weight, and for example, 3% to 5% by weight). If a layer is present in which the binder content is too greater this range, migration of Li ions in that layer is inhibited, thereby resulting in increased susceptibility to increases in the internal resistance value. In addition, if a layer is present in which the binder content is too smaller than this range, the durability of the insulating particle-containing layer (which can have an effect on battery characteristics such as capacity retention rate) may be insufficient.

The binder content in each portion of the insulating particle-containing layer (such as each sub-layer) can be determined by collecting a sample from each portion and analyzing. Normally, the binder content of a composition used to form each portion of the insulating particle-containing layer can be employed as the binder content in each corresponding portion of the insulating particle-containing layer.

In a preferable aspect of the technology disclosed herein, the sub-layers are formed by using a slurry-like composition that contains the insulating particles, the binder and a suitable solvent. Water, an organic solvent or a mixed solvent thereof can be used for the solvent. A solvent of a composition capable of dissolving the binder (and that which is capable of dissolving at least one type of binder in the case of a composition containing a plurality of types of binders) is preferably selected. For example, any solvent selected from among aprotic polar organic solvents or a mixed solvent of two or more types thereof can be used preferably. Preferable examples of aprotic polar organic solvents include cyclic or linear amides such as N-methyl-2-pyrollidone (NMP), N,N-dimethylformamide (DMF) or N,N-dimethylacetoamide (DMAc).

The insulating particle-containing layer disclosed herein can be formed by repeating a procedure consisting of applying (and typically, coating) a slurry corresponding to the composition of each sub-layer onto the surface of the active material layer (or surface of a sub-layer on the inside) and then drying under suitable conditions. Heating may be carried out at a suitable temperature as necessary to accelerate the drying. Although there are no particular limitations thereon, the solid content ratio (ratio of the component that forms the insulating particle-containing layer in the slurry, which may be abbreviated as “NV”) can be, for example, roughly 30% to 80% by weight.

The insulating particle-containing layer in the technology disclosed herein can contain a component other than the insulating particles and the binder provided it does not significantly impair the effects of the present invention. Examples of that component include various types of additives such as a fluidity adjuster of the slurry (such as a thickener), dispersant, preservative or antistatic agent. The content ratios of these additives is preferably 5% by weight or less and more preferably 2% by weight or less based on NV. The insulating particle-containing layer may have a composition consisting substantially of the insulating particles and the binder.

In a preferable aspect, the weight ratio of the insulating particles based on the total weight of the insulating particle-containing layer (namely, the insulating particle content based on the entire insulating particle-containing layer) is 85% by weight or more. The insulating particle content is more preferably 90% by weight or more (and for example, 95% by weight or more). In a configuration containing a plurality of sub-layers, the insulating particle content of each sub-layer is preferably 80% by weight or more (more preferably 85% by weight or more, and for example, 90% by weight or more). An insulating particle-containing layer of such a configuration allows the realization of a battery possessing high reliability (for example, superior performance in preventing internal resistance).

The insulating particle-containing layer preferably does not substantially contain a material that absorbs and releases Li ions (namely, a component that functions as an active material). Since the insulating particle-containing layer of this configuration does not contain a component that fluctuates in volume as a result of charging and discharging, it is suitable for constructing a battery that exhibits superior durability with respect to charge/discharge cycling.

The thickness of the insulating particle-containing layer can be, for example, about 0.5 μm to 20 μm, and normally is preferably about 1 μm to 10 μm (and more preferably, about 2 μm to 7 μm). If the thickness of the insulating particle-containing layer is too greater than the above ranges, the internal resistance values tend to become large. In addition, if the thickness of the insulating particle-containing layer is too smaller than the above ranges, the thickness of the insulating particle-containing layer with respect to the planar direction of the electrode (for example, lengthwise direction of an electrode in the form of a long sheet) may easily become uneven. For similar reasons, each sub-layer that composes the insulating particle-containing layer preferably has a thickness of roughly 0.5 μm or more (and more preferably, roughly 1 μm or more). In order to more effectively exhibit the effects of applying the technology disclosed herein, the innermost layer and the outermost layer both preferably have a thickness of roughly 1 μm or more (for example, roughly 1 μm to 5 μm). In the case the insulating particle-containing layer is composed of two layers consisting of an inner layer and an outer layer, the thickness ratio of these layers (inner layer:outer layer) can be, for example, about 1:0.25 to 1:4. Normally, it is suitable for this thickness ratio to be about 1:0.5 to 1:2 (and preferably, about 1:0.7 to 1:1.3).

A member mainly composed of a metal having good electrical conductivity, such as copper, nickel, aluminum, titanium or stainless steel, can be used for the current collector composing the electrode disclosed herein. A current collector and the like made of copper or an alloy mainly composed of copper (copper alloy) can be preferably employed as constituents of the negative electrode, while a current collector and the like made of aluminum or an alloy mainly composed of aluminum (aluminum alloy) can be preferably employed as constituents of the positive electrode. There are no particular limitations on the shape of the current collector since it can vary corresponding to the shape and the like of the electrode and battery, and can have various forms such as that of a rod, plate, sheet, foil or mesh. The technology disclosed herein can be preferably applied to an electrode that uses a current collector in the form of a sheet. An example of a preferable aspect of a battery constructed using this electrode (electrode sheet) is a battery provided with an electrode unit obtained by winding a sheet-shaped positive electrode and a sheet-shaped negative electrode typically with a sheet-shaped separator (coiled electrode unit). There are no particular limitations on the external appearance of this battery, and can have, for example, a rectangular, flat or cylindrical shape. There are no particular limitations on the thickness and size of the sheet-shaped current collector, and can be suitably selected corresponding to the shape of the target lithium ion battery. For example, a sheet-shaped current collector having a thickness of roughly 5 μm to 30 μm can be used preferably. The width of the current collector can be, for example, about 2 cm to 15 cm, while the length can be, for example, about 5 cm to 1000 cm.

A suitable material selected from various materials known to be able to typically function as a negative electrode active material of a lithium ion battery can be employed for the negative electrode active material. An example of a preferable active material is a particulate carbon material (carbon particles) containing a graphite structure (layered structure) in at least a portion thereof. So-called graphitous materials (graphite), non-graphitizable carbon materials (hard carbon), graphitizable carbon materials (soft carbon) or materials having a combined structure thereof and the like can each be used. For example, natural graphite, mesocarbon microbeads (MCMB) or highly ordered pyrolytic graphite (HOPG) can be used preferably.

The physical form (external form) of the negative electrode active material is preferably particulate. For example, a particulate active material (such as carbon particles) having a mean particle diameter of roughly 5 μm to 50 μm can be used preferably. In particular, carbon particles having a mean particle diameter of roughly 5 μm to 15 μm (and for example, roughly 8 μm to 12 μm) are preferable. Since carbon particles having a comparatively small particle diameter in this manner have a large surface area per unit volume, they can serve as an active material more suitable for rapid charging and discharging (for example, high-output discharge). Thus, a lithium ion battery provided with this active material can be preferably used as a lithium ion battery for vehicle mounting. In addition, since carbon particles having a comparatively small particle diameter as described above exhibit smaller fluctuations in volume of the individual carbon particles accompanying charging and discharging in comparison with the case of using larger particles, the volume fluctuations of the entire active material layer can be buffered (absorbed) to a greater extent. This is advantageous in terms of enhancing capacity retention rate of a battery by increasing adhesion between the active material layer and the insulating particle-containing layer in a battery provided with a negative electrode of a configuration having the insulating particle-containing layer on the active material layer.

In addition to the negative electrode active material described above, the negative electrode active material layer can also contain one type or two or more types of materials capable of being incorporated in the negative electrode active material layer of an ordinary lithium ion battery as necessary. Examples of such materials include various types of polymer materials capable of functioning as binders. For example, in the case of forming the active layer using an aqueous liquid composition (composition that uses water or a mixed solvent mainly composed of water as the dispersion medium of the active material), a polymer material that dissolves or disperses in water can be preferably used for the binder. Examples of polymer materials that dissolve in water (water-soluble polymer materials) include cellulose-based polymers such as carboxymethyl cellulose (CMC), methyl cellulose (MC), cellulose acetate phthalate (CAP), hydroxypropyl methyl cellulose (HPMC) or hydroxypropyl methyl cellulose phthalate (HPMCP); and polyvinyl alcohol (PVA). In addition, examples of polymer materials that disperse in water (water-dispersible polymer materials) include fluorine-based resins such as polytetrafluoroethylene (PTFE), tetrafluoroethylene-perfluoroalkyl vinyl ether copolymer (PFA), tetrafluoroethylene-hexafluoropropylene copolymer (FEP) or ethylene-tetrafluoroethylene copolymer (ETFE); vinyl acetate copolymers; and rubbers such as styrene-butadiene rubber (SBR), acrylic acid-modified SBR resin (SBR-based latex) or gum arabic. Alternatively, in the case of forming the active material layer using a solvent-based liquid composition (composition in which the dispersion medium of the active material is mainly an organic solvent), a polymer material such as polyvinylidene fluoride (PVDF), polyvinylidene chloride (PVDC), polyethylene oxide (PEO), polypropylene oxide (PPO) or polyethylene oxide-polypropylene oxide copolymer (PEO-PPO) can be used. In addition to use as binder, the examples of polymer materials listed above can also be used as thickeners and other additives of a composition for forming the negative electrode active material layer.

The negative electrode active material layer can be preferably produced by applying a liquid composition in which active material particles have been dispersed in a suitable solvent (and typically, a composition for forming a negative electrode active material in the form of a paste or slurry) to a current collector and drying the composition. Water, an organic solvent or a mixed solvent thereof can be used for the solvent. For example, a negative electrode active material composition can be preferably used in which the solvent is an aqueous solvent (water or mixed solvent consisting mainly of water). In addition to the negative electrode active material particles and the solvent, the composition can also contain one type or two or more types of materials able to be incorporated in a liquid composition used to form an active layer material layer in the production of a negative electrode for a typical lithium ion battery as necessary. For example, a composition for forming a negative electrode active material can be used preferably that contains a polymer material (binder) as previously described.

Although there are no particular limitations thereon, NV of the composition can be, for example, about 30% to 60% (and typically, about 30% to 50%). The weight ratio of the negative electrode active material in the solid fraction (component that forms the negative electrode active material layer) can be, for example, roughly 85% or more (and typically, roughly 85% to 99.9%), preferably roughly 90% to 99% and more preferably roughly 95% to 99%.

A technique similar to conventionally known methods can be suitably employed when applying the composition to the negative electrode current collector. For example, a prescribed amount of the composition may be coated onto a surface of the current collector using a suitable coating device (such as a gravure coater, slit coater, die coater or comma coater). There are no particular limitations on the coated amount of the composition for forming a negative electrode active material layer, and can be suitably different corresponding to the shape, target performance and the like of the negative electrode sheet and battery. For example, the composition may be coated onto both sides of the sheet-shaped current collector so that the coated amount as NV (namely, the weight after drying) is roughly about 4 mg/cm² to 20 mg/cm² for both sides combined.

Following coating, the coated composition can be dried with suitable drying means and then pressed as necessary to form the negative electrode active material layer on a surface of the negative electrode current collector. Although there are no particular limitations thereon, the density of the negative electrode active material layer can be roughly about 1.1 g/cm³ to 1.5 g/cm³. The density of the negative electrode active material layer may also be roughly about 1.1 g/cm³ to 1.3 g/cm³. The conditions of the pressing described above may be set so that the negative electrode active material layer is formed that has this density. Various types of conventionally known pressing methods such as roll pressing or plate pressing can be suitably employed for the pressing method.

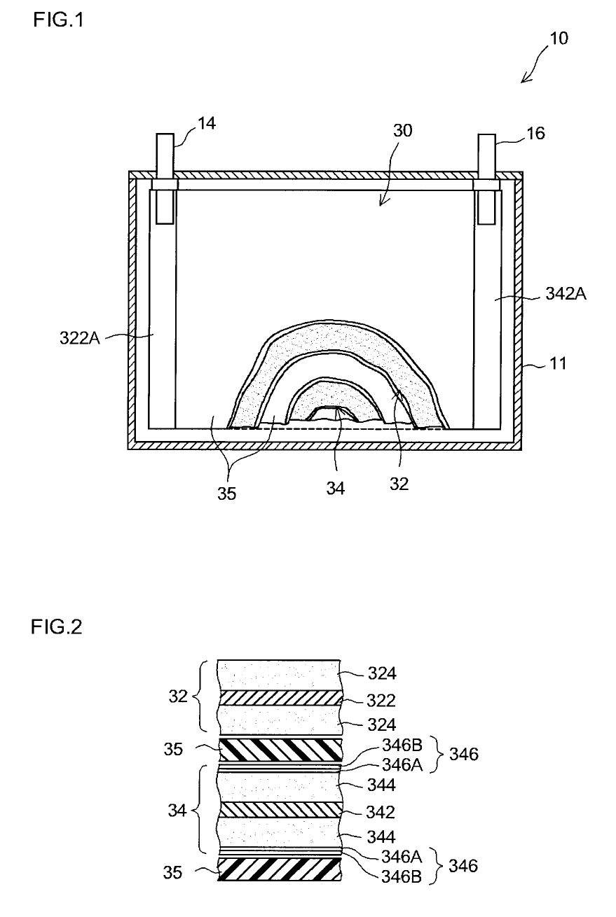

The following provides an explanation of an embodiment of a lithium ion battery provided with an electrode for a lithium secondary battery of the composition disclosed herein that is used as a negative electrode. As shown in FIG. 1, a lithium ion battery 10 according to the present embodiment is provided with a container 11 made of metal (while that made of a resin or a laminated film is also preferable). In this container 11, a coiled electrode unit 30 is housed that is composed by laminating a positive electrode sheet 32, a negative electrode sheet 34 and two separators 35 followed by winding (coiled into a flat shape in the present embodiment).

As shown in FIG. 2, the positive electrode sheet 32 is provided with a positive electrode current collector 322 in the form of a long sheet, and a positive electrode active material layer 324 formed on the surfaces of both sides thereof. A sheet composed of a metal such as aluminum, nickel or titanium (and typically, a metal foil such as aluminum foil having a thickness of about 5 μm to 30 μm) can be preferably used for the positive electrode current collector 322. The positive electrode active material layer 324 is mainly composed of a positive electrode active material capable of absorbing and releasing Li ions. An oxide-based positive electrode active material used in ordinary lithium ion batteries or an oxide-based positive electrode active material having a spinel structure and the like can be preferably used for the positive electrode active material. For example, a positive electrode active material can be used that is mainly composed of a lithium-nickel-based compound oxide, lithium-cobalt-based compound oxide or lithium-manganese-based compound oxide.

Here, the “lithium-nickel compound oxide” includes compound oxides having only Li and Ni as constituent metal elements thereof (and typically, LiNiO₂), as well as compound oxides containing one type or two or more types of metal elements in addition to Li and Ni at a ratio less than that of Ni (in terms of the number of atoms, and in the case of containing two or more types of metal elements other than Li and Ni, a ratio less than that of Ni for any of these metal elements). Examples of these metal elements include one type or two or more types of elements selected from the group consisting of Co, Al, Mn, Cr, Fe, V, Mg, Ti, Zr, Nb, Mo, W, Cu, Zn, Ga, In, Sn, La and Ce. Similarly, a “lithium-cobalt-based compound oxide” includes compound oxides having only Li and Co as constituent metal elements thereof (and typically, LiCoO₂), as well as compound oxides containing one type or two or more types of metal elements in addition to Li and Co at a ratio less than that of Co, while a “lithium-manganese-based compound oxide” includes compound oxides having only Li and Mn as constituent metal elements thereof (and typically, LiMn₂O₄), as well as compound oxides containing one type or two or more types of metal elements in addition to Li and Mn at a ratio less than that of Mn.

The positive electrode active material layer 324 can contain a binder and an electrically conductive material in addition to the positive electrode active material. A binder similar to that used for the previously described negative electrode active material composition can be used for the binder. Examples of electrically conductive materials that can be used various types of carbon black (such as acetylene black, furnace black or ketjen black), carbon powder in the manner of graphite powder, and metal powder in the manner of nickel powder. Although there are no particular limitations thereon, the amount of the electrically conductive material used based on 100 parts by weight of the positive electrode active material can be within the range of, for example, 1 part to 20 parts by weight (and preferably, 5 parts to 15 parts by weight). In addition, the amount of the binder used based on 100 parts by weight of the positive electrode active material can be within the range of, for example, 0.5 parts to 10 parts by weight.

In forming the positive electrode active material layer 324, a positive electrode active material layer forming material (here, a water-mixed type paste-like positive electrode mixture) typically prepared by mixing a preferable positive electrode active material as previously described with a suitable electrically conductive material, a binder and water (such as ion exchanged water) is coated onto the surfaces on both sides of the positive electrode current collector 322 followed by drying the coated material at suitable temperature range to a degree that does not cause deterioration of the active material (and typically, 70° C. to 150° C.). As a result, the positive electrode active material layer 324 can be formed at a desired site (site corresponding to the coating range of the positive electrode active material composition) on the surfaces of both sides of the positive electrode current collector 322. The thickness and density of the positive electrode active material layer 324 can be suitably adjusted by carrying out suitable pressing treatment (such as roll pressing treatment) as necessary.

The negative electrode sheet (electrode with insulating particle-containing layer) 34 is provided with a negative electrode current collector 342 in the form of a long sheet, a negative electrode active material layer 344 formed on a surface thereof (such as a layer mainly composed of graphite particles serving as the negative electrode active material), and an insulating particle-containing layer 346 formed on the negative electrode active material layer. The negative electrode active material layer 344 is obtained in the same manner as in the positive electrode by coating a preferable negative electrode active material composition as previously described onto the surfaces on both sides of the negative electrode current collector 342, drying at a suitable temperature, and carrying out suitable density adjustment treatment (such as roll pressing treatment) as necessary.

The insulating particle-containing layer 346 has a bilayer structure composed of an inner layer (innermost layer) 346A that composes a portion facing the negative electrode active material layer, and an outer layer (outermost layer) 346B that composes a portion facing the outer surface. Both the inner surface 346A and the outer surface 346B contain insulating particles at 90% by weight or more, and the total amount of the insulating particles and binder accounts for 95% by weight or more of both layers. The binder content C_{IN} of the inner layer 346A is higher than the binder content C_{OUT} of the outer layer 346B, and the value of C_{IN}/C_{OUT} is preferably 1.02 to 1.25 (and more preferably, 1.1 to 1.25). The insulating particle-containing layer 346 employing this configuration can be preferably formed by coating a slurry of a composition corresponding to the inner layer 346A onto a surface of the negative electrode active material layer 344, drying, and then coating a slurry of a composition corresponding to the outer layer 346B over the inner layer 346A followed by drying.

Various types of porous sheets that are known to be able to be used as separators of lithium ion batteries can be used for the separators 35 used by superimposing with the positive electrode 32 and the negative electrode 34. For example, a porous resin sheet (film) composed of a polyolefin resin such as polyethylene or polypropylene can be used preferably. Although there are no particular limitations thereon, an example of the physical properties of a preferable porous sheet (and typically, a porous resin sheet) is a porous resin sheet in which the mean pore diameter is about 0.0005 μm to 30 μm (and more preferably, 0.001 μm to 15 μm) and the thickness is about 5 μm to 100 μm (and more preferably, 10 μm to 30 μm). The porosity of the porous sheet can be, for example, roughly about 20% to 90% by volume (and preferably, 30% to 80% by volume).

As shown in FIG. 1, a portion where the positive electrode active material layer 324 is not formed (active material layer non-formed portion 322A) is provided on one end of the positive electrode sheet 32 along the lengthwise direction thereof. In addition, a portion where the negative electrode active material layer 344 and the insulating particle-containing layer 346 are not formed (active material layer non-forming portion 342A) is provided on one end of the negative electrode sheet 34 along the lengthwise direction thereof. When the positive and negative electrode sheets 32 and 34 are superimposed with the two separators 35, the positive and negative electrode sheets 32 and 34 are superimposed while slightly offsetting so that, together with superimposing both of the active material layers 324 and 344, the active material layer non-forming portion 322A of the positive electrode sheet and the active material layer non-forming portion 342A of the negative electrode sheet are separately arranged on one end and the other end along the lengthwise direction. While in this state, the total of four sheets 32, 35, 34 and 35 are coiled, followed by flattening the resulting coiled body by pressing from the sides to obtain the flat coiled electrode unit 30.

Next, the resulting coiled electrode unit 30 is respectively electrically connected to a positive electrode terminal 14 and a negative electrode terminal 16. The electrode unit 30 connected to the terminals 14 and 16 is then housed in the container 11, and the container 11 is sealed after arranging (pouring) a suitable non-aqueous electrolyte solution therein. In this manner, construction (assembly) of the lithium ion battery 10 according to the present embodiment is completed. Subsequently, suitable conditioning treatment is carried out (initial charging and discharging treatment consisting of, for example, charging at a constant current for 3 hours at a charging rate of 1/10 C followed by charging at a constant current and constant voltage to 4.1 V at a charging rate of ⅓ C and discharging at a constant current to 3.0 V at a charging rate of ⅓ C, and repeating this procedure 2 to 3 times) to allow the obtaining of the lithium ion battery 10. Furthermore, a non-aqueous electrolyte solution similar to that used in typical lithium ion batteries can be used for the non-aqueous electrolyte solution. For example, a non-aqueous electrolyte solution containing a lithium salt (supporting salt) such as LiPF₆ at a concentration of roughly about 0.1 mol/L to 5 mol/L (and for example, roughly 0.8 mol/L to 1.5 mol/L) in a mixed solvent suitably combining carbonates such as ethylene carbonate (EC), propylene carbonate (PC), diethyl carbonate (DEC), dimethyl carbonate (DMC) or ethylmethyl carbonate (EMC) can be used preferably.

In carrying out the invention disclosed herein, although it is not necessary to clarify the reason for being able to realize a high-performance battery by using an insulating particle-containing layer of the previously described configuration, an example of a reason for this is discussed below. Namely, in the initial state shown on the left side of FIG. 4 (state when the battery has been assembled), the negative electrode active material layer 344 formed on the negative electrode current collector 342 is in a state in which it is suitably filled with active material particles 42 (such as graphite particles) that compose the active material layer 344. However, when this battery is charged and discharged, the active material particles 42 expand and contract accompanying insertion and elimination of Li. Consequently, as the number of charge/discharge cycles increases, the filled state of the active material particles 42 in the active material layer 344 changes from the initial state as shown on the right side of FIG. 4 (and typically, filling of the active material particles 42 relaxes as an overall trend), and continuity between a portion of the active material particles 42A and the main portion of the active material layer 344 (and in turn, the current collector 342) tends to be interrupted. In this manner, the dissociation of a portion of the active material particles 42A from the current collector in this manner (which prevents them from contributing to battery capacity) can cause a decrease in capacity retention rate, thereby making this undesirable.

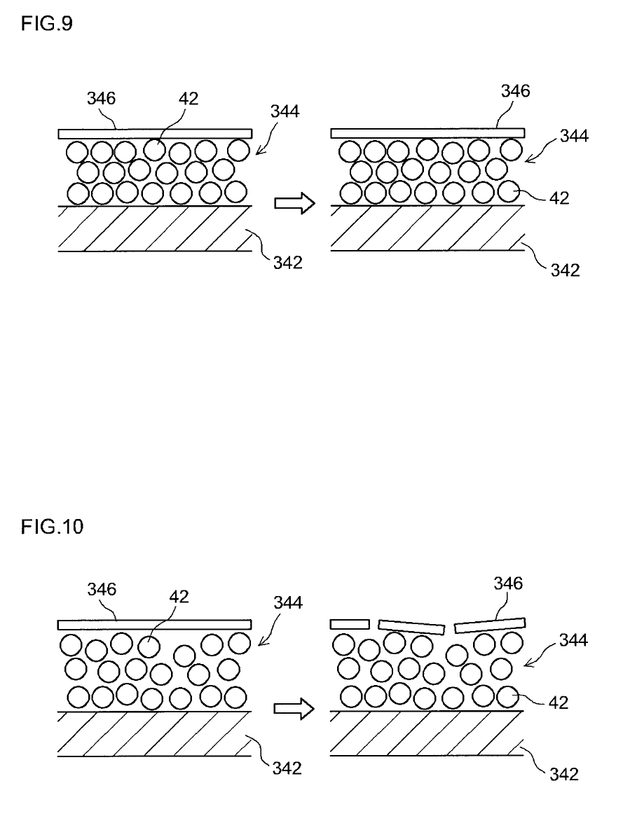

In the electrode disclosed herein, as shown on the left side of FIG. 9, the insulating particle layer 346 containing insulating particles 44 and a binder 46 is provided on the active material layer 344. Changes in the filled state of the active material particles 42 (relaxation of filling) can be suppressed by covering the active material layer 344 with the insulating particle-containing layer 346 in this manner. Thus, as shown on the right side of FIG. 9, a suitable filled state of the active material particles 42 is maintained even after repeated charging and discharging (for example, events such as relaxation of filling of the active material particles 42 as shown on the right side of FIG. 4 or dissociation of a portion of the active material particles 42A from the current collector are prevented), and as a result thereof, capacity retention rate of the battery can be improved. In addition, a configuration in which the active material layer 344 is covered with the insulating particle-containing layer 346 can also be useful for improving battery reliability.

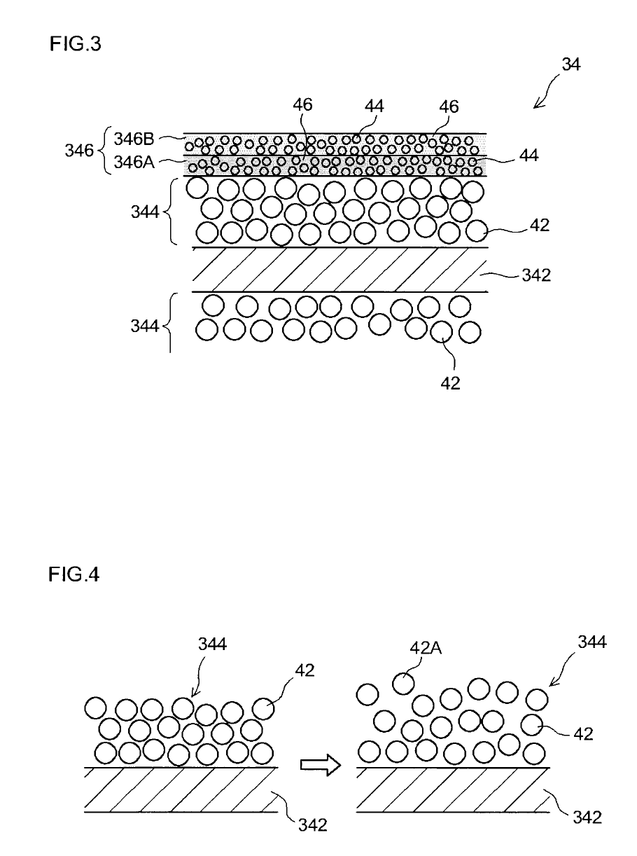

In a preferable aspect of the battery disclosed herein, as shown in FIG. 3, the binder content C_{IN} of the inner layer 346A that composes the portion of the insulating particle-containing layer 346 that faces the active material layer is higher than the binder content C_{OUT} of the outer layer 3468 that composes the portion that faces the outside. As a result, together with exhibiting the effect of improving the favorable reliability of the insulating particle-containing layer 346 overall, since adhesion between the inner layer 346A and the active material layer 344 is enhanced, capacity retention rate can be effectively improved and increases in internal resistance are thought to be suppressed since inhibition of migration of Li ions in the outer layer 3468 is reduced.

In a preferable aspect of the battery disclosed herein, the insulating particle-containing layer containing the insulating particles and the binder that binds the insulating particles is provided on the active material layer having surface roughness Ra of roughly 2.5 μm to 42 μm (and for example, 5 μm to 30 μm). Here, “surface roughness Ra” refers to calculated average roughness Ra defined in JIS B 0601 (2001). According to an electrode employing this configuration (and preferably, a negative electrode), a lithium secondary battery (and typically, a lithium ion battery) can be constructed that has an even batter capacity retention rate.

The reason why making surface roughness Ra of the active material layer to be within the above range improves capacity retention rate is believed, for example, to be as indicated below. Namely, if surface roughness Ra is too smaller than the above range, the surface of the active material layer becomes excessively smooth and adhesion (bonding strength) between the active material layer and the insulating particle-containing layer tends to be inadequate. Consequently, as shown on the left side of FIG. 8, even if the insulating particle-containing layer 346 is suitably provided on the active material layer 344 in the initial state, as a result of repeated charging and discharging, a portion of the insulating particle-containing layer 346 can separate from the active material layer 344 or gaps can form in the insulating particle-containing layer 346 due to expansion and contraction of the active material particles 42 (and in turn, expansion and contraction of the entire active material layer 344) accompanying the charging and discharging as shown in, for example, the right side of FIG. 8.

On the other hand, if surface roughness Ra is too greater than the above range, since there are large surface irregularities in the surface of the active material layer, it becomes difficult to form the insulating particle-containing layer as a result of tightly adhering to these surface irregularities. Consequently, as shown on the left side of FIG. 10, fine gaps easily form between the insulating particle-containing layer 346 and the active material layer 344. If charging and discharging are repeated while in this state, adhesion between the insulating particle-containing layer 346 and the active material layer 344 becomes inadequate, and separation of the insulating particle-containing layer 346 can occur or a portion of the insulating particle-containing layer 346 can collapse into gaps lying behind it resulting in the formation of gaps in the insulating particle-containing layer 346 as shown on the right side of FIG. 10.

If separation or gap formation occurs in the insulating particle-containing layer 346, the effect of suppressing changes in the filled state of the active material particles 42 tends to weaken. In contrast, if surface roughness Ra of the active material layer is made to be within the preferable range previously described, the presence of suitable surface irregularities in the surface result in the demonstration of anchoring effects, thereby making it possible to enhance adhesion between the insulating particle-containing layer 346 and the active material layer 344, and avoid problems such as collapse of the insulating particle-containing layer 346. Thus, as shown on the right side of FIG. 9, the insulating particle-containing layer 346 can be maintained in a favorable state even after charge/discharge cycling, and as a result, a suitable filled state of the active material particles 42 can be maintained at a high level. It is particularly significant to make surface roughness Ra of the active material layer to be within the above range in an electrode (and typically, a negative electrode for a lithium ion battery) of a configuration in which the insulating particle-containing layer is provided on the active material layer mainly composed of carbon particles (such as graphite particles) for the active material.

There are no particular limitations on the method used to adjust surface roughness Ra of the active material layer to be within the above range. For example, surface roughness Ra of the active material layer can be adjusted by suitably setting one or two or more conditions among physical properties of the composition used to form the active material layer (such as NV or viscosity), selection of the solvent that composes the composition, drying conditions of the composition, physical properties of the active material particles (such as mean particle diameter or particle size distribution), selection of the binder, the weight ratio between the active material particles and the binder and the like. For example, by using a composition having comparatively large NV (for example, NV of roughly 40% by weight or more) for the composition for forming an active material layer, surface roughness Ra can be increased by drying the composition at a higher temperature (rapidly), while surface roughness Ra can be decreased by drying at a lower temperature (slowly).

In addition to the effect of making surface roughness Ra of the active material layer to be within the above range being favorably exhibited in an aspect in which the active material layer is combined with an insulating particle-containing layer in which the binder content of the inside portion is higher than that of the outside portion, it can also be favorably exhibited in a combination with an insulating particle-containing layer of a configuration that is free of this bias in the binder content.

Although the following provides an explanation of examples relating to the present invention, the present invention is not intended to be limited to that indicated in these specific examples.

### Example 1

Natural graphite (negative electrode active material) having a mean particle diameter of 10 μm, SBR and CMC were mixed with ion exchanged water so that the weight ratio of these materials was 98:1:1 and NV was 45% by weight to prepare a slurry-like negative electrode active material composition. The composition was coated onto both sides of a long piece of copper foil (negative electrode current collector) having a thickness of about 15 μm so a total coated amount on both sides (as NV) of 8.6 mg/cm², followed by drying at 115° C. and pressing so that the density of the negative electrode active material layer was 1.3 g/cm³. The coated range of the negative electrode active material composition on both sides was a range that left a band having a width of about 15 mm on one edge of the current collector along the lengthwise direction. A negative electrode raw material having the negative electrode active material layer on both surfaces of the negative electrode current collector was obtained in this manner.

α-alumina particles (insulating particles) having a mean particle diameter of 0.8 μm and an acrylic binder were mixed with N-methylpyrrolidone (NMP) so that the weight ratio of these materials was 96:4 (namely, the binder content was 4% by weight) and NV was 50% by weight to prepare a slurry-like coating agent (composition for forming the insulating particle-containing layer) A1. The coating agent A1 was coated on the surface of the negative electrode active material layer formed on both sides of the negative electrode raw material followed by drying to form insulating particle-containing layers. The coated amount of the coating agent A1 was adjusted so that the thickness as NV (namely, the thickness of the insulating particle-containing layer formed after drying) was 4 μm. A sheet-shaped negative electrode (negative electrode sheet) having an insulating particle-containing layer on the negative electrode active material layers was obtained in this manner. The lithium ion battery 10 having the general configuration shown in FIG. 1 was produced using this negative electrode sheet (electrode with insulating particle-containing layer).

The following was used as a positive electrode sheet. Namely, lithium nickel oxide (LiNiO₂) powder, acetylene black, PTFE and CMC were mixed with ion exchanged water so that the weight ratio of these materials was 89:5:5:1 to prepare a slurry-like positive electrode active material composition. The composition was coated onto surfaces on both sides of a long piece of aluminum foil (positive electrode current collector) having a thickness of 10 μm so that the total coated amount on both sides (as NV) was 10 mg/cm². The coated composition was then dried followed by pressing to obtain a positive electrode sheet. The coated range of the positive electrode active material composition on both sides was a range that left a band having a width of about 17 mm on one edge of the positive electrode current collector along the lengthwise direction.

The negative electrode sheet and the positive electrode sheet produced as described above were superimposed with two separators (here, porous polypropylene sheets having a thickness of 30 μm were used) there between. At this time, both of the electrode sheets were superimposed while slightly offset so that the positive electrode active material layer non-forming portion (the band-shaped portion of the positive electrode sheet) and the negative electrode active material layer non-forming portion (the band-shaped portion of the negative electrode sheet) were arranged on opposite sides in the direction of width. This laminated sheet was then coiled in the lengthwise direction, and a flat electrode unit was formed by flattening the coiled body by pressing from the sides.

An aluminum positive electrode terminal and a copper negative electrode terminal were respectively welded to the positive electrode active material layer non-forming portion and the negative electrode active material layer non-forming portion protruding from the separators on both ends of this electrode unit in the axial direction. This was then housed in a flat prismatic container together with a non-aqueous electrolyte solution (here, an electrolyte solution was used having a composition in which LiPF₆ was dissolved at a concentration of 1 mol/L in a mixed solvent of EC, DMC and EMC at a volume ratio of 1:1:1) followed by sealing the opening of the container to construct a lithium ion battery.

### Example 2

In this example, two types of coating agents were used for the coating agent used to form the insulating particle-containing layer, consisting of a coating agent A2 containing insulating particles and binder at a weight ratio of 96:4.04 (binder content of 4.04% by weight representing a 1% increased based on the coating agent A1), and a coating agent B2 containing these at a weight ratio of 96:3.96 (binder content of 3.96% by weight representing a 1% decrease based on the coating agent A1). The coating agent A2 was first coated onto a surface of the negative electrode active material layer of a negative electrode raw material produced in the same manner as Example 1 to a thickness as NV of 2 μm and dried. Next, the coating agent B2 was coated thereon to a thickness as NV of 2 μm and dried. Thus, an insulating particle-containing layer was formed on the surface of the active material layer that was composed of two layers consisting of a sub-layer formed form the coating agent A2 (inner layer) and a sub-layer formed from the coating agent B2 (outer layer). C_{IN}/C_{OUT} of this insulating particle-containing layer was 1.02. A negative electrode sheet was then produced in the same manner as Example 1 with the exception of that described above, and a lithium ion battery was constructed in the same manner as Example 1 using this negative electrode sheet.

### Example 3

In this example, two types of coating agents were used for the coating agent used to form the insulating particle-containing layer, consisting of a coating agent A3 containing insulating particles and binder at a weight ratio of 96:4.2 (binder content of 4.19% by weight representing a 5% increased based on the coating agent A1), and a coating agent B3 containing these at a weight ratio of 96:3.8 (binder content of 3.81% by weight representing a 5% decrease based on the coating agent A1) (C_{IN}/C_{OUT}=1.10). A negative electrode sheet was then produced in the same manner as Example 2 with the exception of that described above, and a lithium ion battery was constructed in the same manner as Example 2 using this negative electrode sheet.

### Example 4

In this example, two types of coating agents were used for the coating agent used to form the insulating particle-containing layer, consisting of a coating agent A4 containing insulating particles and binder at a weight ratio of 96:4.32 (binder content of 4.31% by weight representing an 8% increased based on the coating agent A1), and a coating agent B4 containing these at a weight ratio of 96:3.68 (binder content of 3.69% by weight representing an 8% decrease based on the coating agent A1) (C_{IN}/C_{OUT}=1.17). A negative electrode sheet was then produced in the same manner as Example 2 with the exception of that described above, and a lithium ion battery was constructed.

### Example 5

In this example, two types of coating agents were used for the coating agent used to form the insulating particle-containing layer, consisting of a coating agent A5 containing insulating particles and binder at a weight ratio of 96:4.48 (binder content of 4.46% by weight representing a 12% increased based on the coating agent A1), and a coating agent B5 containing these at a weight ratio of 96:3.52 (binder content of 3.54% by weight representing a 12% decrease based on the coating agent A1) (C_{IN}/C_{OUT}=1.26). A negative electrode sheet was then produced in the same manner as Example 2 with the exception of that described above, and a lithium ion battery was constructed.

### Example 6

In this example, two types of coating agents were used for the coating agent used to form the insulating particle-containing layer, consisting of a coating agent A6 containing insulating particles and binder at a weight ratio of 96:4.8 (binder content of 4.76% by weight representing a 20% increased based on the coating agent A1), and a coating agent B6 containing these at a weight ratio of 96:3.2 (binder content of 3.23% by weight representing a 20% decrease based on the coating agent A1) (C_{IN}/C_{OUT}=1.47). A negative electrode sheet was then produced in the same manner as Example 2 with the exception of that described above, and a lithium ion battery was constructed.

TABLE 1

| | | Insulating | | |
|---|---|---|---|---|
| | | particles | Binder | |
| | | (parts by | (parts by | |
| | | weight) | weight) | C_{IN}/C_{OUT} |
| Example 1 | | 96 | 4 | — |
| Example 2 | Inner layer | 96 | 4.04 | 1.02 |
| | Outer layer | 96 | 3.96 | |
| Example 3 | Inner layer | 96 | 4.2 | 1.10 |
| | Outer layer | 96 | 3.8 | |
| Example 4 | Inner layer | 96 | 4.32 | 1.17 |
| | Outer layer | 96 | 3.68 | |
| Example 5 | Inner layer | 96 | 4.48 | 1.26 |
| | Outer layer | 96 | 3.52 | |
| Example 6 | Inner layer | 96 | 4.8 | 1.47 |
| | Outer layer | 96 | 3.2 | |

[Internal Resistance Value]

The lithium ion battery according to each example was charged under constant temperature conditions of 25° C. at a constant current of 1 C (here, 5 A) to an inter-terminal voltage of 3.7 V, followed by charging at a constant voltage and adjusting to a 60% charged state (SOC: state of charge). The batteries following constant-current and constant-voltage (CC-CV) charging were alternately discharged and charged for 10 seconds under conditions of 8 C, 12 C and 20 C, and a graph was prepared of their I-V characteristics. Initial IV resistance values (mΩ) at 25° C. were calculated from the slope of this graph. The results are shown in FIG. 5.

[Capacity Retention Rate (500 Cycles)]

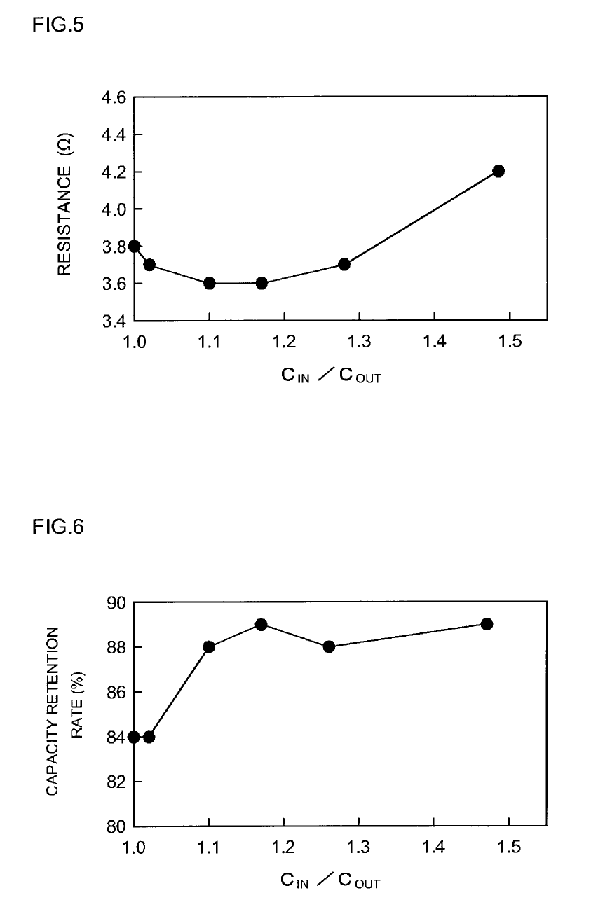

The lithium ion battery according to each example was charged under constant temperature conditions of 25° C. at a constant current of 1 C (here, 5 A) to an inter-terminal voltage of 4.1 V, followed by charging at a constant voltage for a total charging time of 2 hours. After holding the batteries following CC-CV charging for 24 hours at 25° C., the batteries were discharged at 25° C. from 4.1 V to 3.0 V at a constant current of 1 C, followed by discharging at a constant voltage for a total discharging time of 2 hours and then measuring discharge capacity at this time (initial capacity). Next, a procedure consisting of charging at 60° C. from 3.0 V to 4.1 V at a constant current of 2 C, and a procedure consisting of discharging from 4.1 V to 3.0 V at a constant current of 2 C, were alternately repeated for 500 cycles. Following this charge/discharge cycling, the batteries were discharged at 25° C. from 4.1 V to 3.0 V at a constant current of 1 C, followed by discharging at a constant voltage for a total discharging time of 2 hours and measuring discharge capacity at this time (post-cycling capacity). Capacity retention rates (%) for the 500 cycles of charging and discharging were then determined according to the following equation: {(post-cycling capacity)/(initial capacity)}×100. The results are shown in FIG. 6.

As shown in FIG. 5, according to Examples 2 to 5, in which the binder content of the inside portion of the insulating particle-containing layer is 1.02 times to 1.3 times that of the outside portion (namely, C_{IN}/C_{OUT}=1.02 to 1.3), internal resistance values were able to be decreased in comparison with Example 1, in which a different was not provided between binder contents of the inside portion and outside portion of the insulating particle-containing layer (namely, C_{IN}/C_{OUT}=1). Even better results were obtained with Examples 2 to 4, in which C_{IN}/C_{OUT} was within the range of 1.02 to 1.25. Particularly favorable results were obtained with Examples 2 and 3, in which C_{IN}/C_{OUT} was within the range of 1.1 to 1.2. In addition, as shown in FIG. 6, in Examples 3 to 6 in which C_{IN}/C_{OUT} was 1.05 or more, capacity retention rates after 500 cycles improved considerably as compared with Examples 1 and 2 in which C_{IN}/C_{OUT} was 1 or less than 1.05. Particularly favorable results were obtained with Examples 4 to 6 in which C_{IN}/C_{OUT} was 1.1 or more. On the basis of these results, making the range of C_{IN}/C_{OUT} to be 1.1 to 1.25 (and preferably, 1.1 to 1.2) was confirmed to effectively suppress increases in internal resistance while making it possible to further improve capacity retention rate.

### Examples 7 to 11

Negative electrode raw materials were produced in the same manner as Example 1 with the exception of changing the drying temperature of the negative electrode active material composition to the temperatures shown in Table 2. Surface roughness Ra of the surface of the negative electrode active material layer was measured using the Model “VK-8500” laser microscope manufactured by Keyence Corp. for the negative electrode raw materials according to these Examples 7 to 11 and for the negative electrode raw material according to Example 1. Those results are shown in Table 2.

TABLE 2

| | Drying | Surface |
|---|---|---|
| | temperature | roughness |
| | (° C.) | Ra (μm) |
| Example 1 | 115 | 1.2 |
| Example 7 | 120 | 2.5 |
| Example 8 | 155 | 8 |
| Example 9 | 165 | 14 |
| Example 10 | 180 | 42 |
| Example 11 | 190 | 62 |

Insulating particle-containing layers were formed by coating the same coating agent A1 used in Example 1 onto the surfaces of the negative electrode raw materials according to Examples 7 to 11 to a coated thickness as NV of 4 μm followed by drying. Negative electrode sheets according to each example were obtained in this manner. Lithium ion batteries were constructed in the same manner as Example 1 using these negative electrode sheets.

[Capacity Retention Rate (2000 Cycles)]

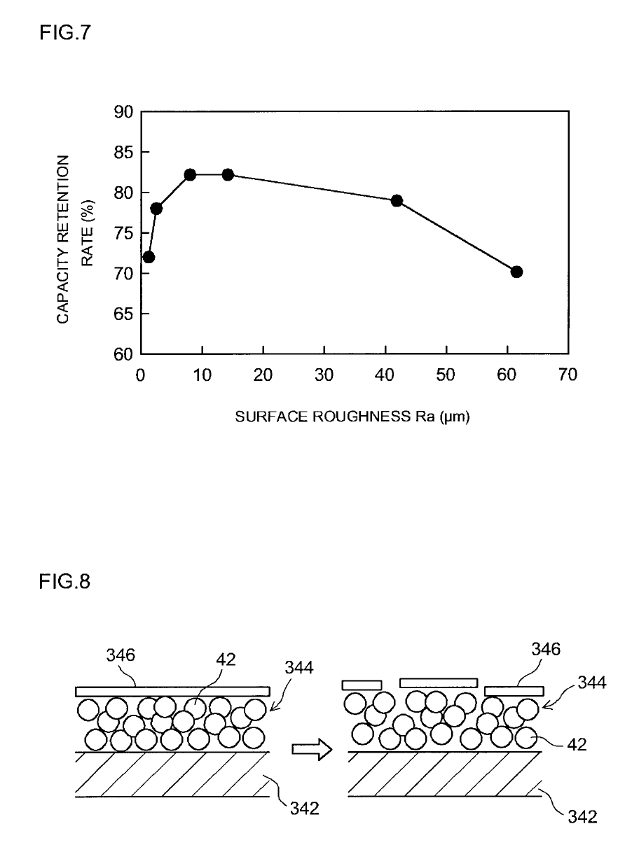

The lithium ion batteries according to Examples 1 and 7 to 11 were charged under constant temperature conditions of 25° C. at a constant current of 1 C (here, 5 A) to an inter-terminal voltage of 4.1 V, followed by charging at a constant voltage for a total charging time of 2 hours. After holding the batteries following CC-CV charging for 24 hours at 25° C., the batteries were discharged at 25° C. from 4.1 V to 3.0 Vat a constant current of 1 C, followed by discharging at a constant voltage for a total discharging time of 2 hours and then measuring discharge capacity at this time (initial capacity). Next, a procedure consisting of charging at 60° C. from 3.0 V to 4.1 V at a constant current of 2 C, and a procedure consisting of discharging from 4.1 V to 3.0 V at a constant current of 2 C, were alternately repeated for 2000 cycles. Following this charge/discharge cycling, the batteries were discharged at 25° C. from 4.1 V to 3.0 V at a constant current of 1 C, followed by discharging at a constant voltage for a total discharging time of 2 hours and measuring discharge capacity at this time (post-cycling capacity). Capacity retention rates (%) for the 2000 cycles of charging and discharging were then determined according to the following equation: {(post-cycling capacity)/(initial capacity)}×100. The results are shown in FIG. 7 as the relationship between surface roughness Ra of the negative electrode active material layer and capacity retention rate.

As shown in FIG. 7, according to Examples 7 to 10, in which surface roughness Ra of the active material layer was 2.5 μm to 42 μm, capacity retention rates after 2000 cycles were able to be further improved in comparison with Example 1, in which surface roughness Ra was below the previously defined range, and Example 11, in which surface roughness Ra exceeded the previously defined range. Particularly favorable results were obtained with Examples 8 and 9 in which surface roughness Ra of the active material layer was within the range of 5 μm to 30 μm. Thus, the effect of making surface roughness Ra of the active material layer to be within a preferable range enables the realization of a lithium ion battery that exhibits an even higher level of capacity retention rate (and particularly capacity retention rate at a high rate of cycling of 2 C or more) by combining with a configuration in which the binder content of the inside portion of the insulating particle-containing layer is higher than that of the outside portion.

Although the above has provided a detailed explanation of specific examples of the present invention, these are only intended to serve as examples, and do not limit the scope of the present invention. The technology described in the claims includes various variations and modifications of the previously described specific examples. For example, the technology disclosed herein can be applied to an electrode of a configuration in which any of the above-mentioned insulating particle-containing layers is provided on a positive electrode active material layer as previously described (electrode with insulating particle-containing layer), the production of that electrode, a lithium secondary battery (and typically, a lithium ion battery) constructed using the electrode, and the production thereof. A negative electrode of a configuration not having an insulating particle-containing layer on an active material layer may be used for the negative electrode in this case, or a negative electrode of a configuration in which any of the above-mentioned insulating particle-containing layers is provided on a negative electrode active material layer (negative electrode with insulating particle-containing layer) may be used.

In addition, the following are also included in matters disclosed herein.

(1) An electrode (and preferably, a negative electrode) used as a constituent of a lithium secondary battery (and typically, a lithium ion battery), having a configuration in which:

an active material layer mainly composed of an active material is retained on a current collector, and an insulating particle-containing layer containing insulating particles and a binder that binds the insulating particles, is provided on the active material layer, and

a portion of the insulating particle-containing layer facing the active material layer contains the binder at a higher weight content than a portion of the insulating particle-containing layer facing an outer surface.

(2) The electrode described in (1) above, wherein the insulating particle-containing layer contains two or more sub-layers in which weight contents of the binder differ, and a binder content C_{IN} of an innermost layer among the sub-layers is higher than a binder content C_{OUT} of an outermost layer.

(3) The electrode described in (2) above, wherein the binder content C_{IN} of the innermost layer among the sub-layers that compose the insulating particle-containing layer is highest, and the binder content C_{OUT} of the outermost layer is lowest.

(4) The electrode described in (2) or (3) above, wherein the binder content C_{IN} of the innermost layer is 1.02 times to 1.25 times (and preferably, 1.1 times to 1.25 times) the binder content C_{OUT} of the outermost layer.

(5) The electrode described in any of (1) to (4) above, wherein surface roughness Ra of the active material layer is within the range of 2.5 μm to 42 μm (and for example, 5 μm to 30 μm).

(6) An electrode (and preferably, a negative electrode) used as a constituent of a lithium secondary battery (and typically, a lithium ion battery), having a configuration in which:

an active material layer mainly composed of an active material is retained on a current collector, and an insulating particle-containing layer containing insulating particles and a binder that binds the insulating particles, is provided on the active material layer, and

surface roughness Ra of the active material layer is within a range of 2.5 μm to 42 μm (and for example, 5 μm to 30 μm).

(7) A method for producing an electrode (and preferably, a negative electrode) used as a constituent of a lithium secondary battery (and typically, a lithium ion battery), comprising:

preparing an electrode raw material in which an active material layer mainly composed of an active material is retained on a current collector;

preparing a plurality of types of compositions containing insulating particles and a binder in which weight ratios of the binder (binder content) in the solid fraction of the composition (insulating particle-containing layer forming component) mutually differ; and

forming an insulating particle-containing layer by sequentially coating the plurality of types of compositions on a surface of the active material layer and drying the compositions, wherein

a composition that has a higher binder content than the last composition coated (composition that forms the portion that is farthest to the outside) is used for the composition initially coated when forming the insulating particle-containing layer (namely, the composition that forms the portion of the insulating particle-containing layer closest to the active material layer).

(8) The method described in (7) above, wherein the composition having the highest binder content among the plurality of types of compositions used to form the insulating particle-containing layer is coated first, and the composition having the lowest binder composition is coated last.

(9) The method described in (7) or (8) above, wherein the binder content of the composition coated first is 1.02 times to 1.25 times (and preferably, 1.1 times to 1.25 times) the binder content of the composition coated last.

(10) The method described in any of (7) to (9) above, wherein preparation of the electrode raw material includes formation of an active material for which surface roughness Ra is within a range of 2.5 μm to 42 μm (and for example, 5 μm to 30 μm).

(11) A method for producing an electrode (and preferably, a negative electrode) used as a constituent of a lithium secondary battery (and typically, a lithium ion battery), comprising:

preparing an electrode raw material in which an active material layer mainly composed of an active material is retained on a current collector, wherein the active material layer is formed so that surface roughness Ra is 2.5 μm to 42 μm (and for example, 5 μm to 30 μm); and

forming an insulating particle-containing layer by applying a composition containing insulating particles and a binder to the active material layer.

### INDUSTRIAL APPLICABILITY

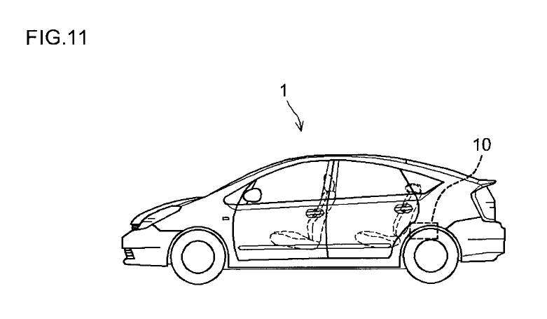

As has been previously described, the lithium secondary battery (and typically, lithium ion battery) provided according to the technology disclosed herein possesses high reliability as a result of being able to highly suppress micro short-circuiting, and since it is also able to exhibit superior input/output performance and durability, can be preferably used as a power source for a motor installed in a vehicle such as an automobile in particular. Thus, as schematically shown in FIG. 11, the present invention provides a vehicle (and typically, and automobile, and particularly an automobile provided with a motor in the manner of a hybrid vehicle, electric vehicle or fuel cell electric vehicle) 1 provided with any of the lithium ion batteries 10 disclosed herein (which can be in the form of a battery assembly formed by connecting a plurality of the batteries 10 in series) as a power source thereof.

1. A lithium secondary battery comprising:
a positive electrode;
a negative electrode; and
a non-aqueous electrolyte, wherein
at least one of the positive electrode and the negative electrode is an electrode provided with an insulating particle-containing layer having a configuration in which an active material layer mainly composed of an active material is retained on a current collector, and the insulating particle-containing layer containing insulating particles and a binder that binds the particles is provided on the active material layer, and
a portion of the insulating particle-containing layer facing the active material layer contains the binder at a higher weight content than that of a portion of the insulating particle-containing layer facing an outer surface thereof.

2. The battery according to claim 1, wherein the insulating particle-containing layer includes two or more sub-layers in which weight contents of the binder differ, and a binder content C_{IN} of an innermost layer among the sub-layers is higher than a binder content C_{OUT} of an outermost layer.

3. The battery according to claim 2, wherein the binder content C_{IN} of the innermost layer among the sub-layers that compose the insulating particle-containing layer is highest, while the binder content C_{OUT} of the outermost layer is lowest.

4. The battery according to claim 2, wherein the binder content C_{IN} of the innermost layer is 1.02 times to 1.25 times the binder content C_{OUT} of the outermost layer.

5. The battery according to claim 2, wherein the binder content C_{IN} of the innermost layer is 1.1 times to 1.25 times the binder content C_{OUT} of the outermost layer.

6. The battery according to claim 1, the battery being constructed as a lithium ion battery that uses the electrode provided with an insulating particle-containing layer as a negative electrode.

7. A vehicle comprising the battery according to claim 1.
